(19) United States
(12) Patent Application Publication
(10) Pub. No.: US 2018/0214817 A1
(43) Pub. Date: Aug. 2, 2018

(54) ADSORBENT FOR A TEMPERATURE SWING ADSORPTION METHOD

(71) Applicant: Linde Aktiengesellschaft, Munchen (DE)

(72) Inventor: Benedikt SCHURER, Munchen (DE)

(73) Assignee: Linde Aktiengesellschaft, Munchen (DE)

(21) Appl. No.: 15/746,525

(22) PCT Filed: Jul. 14, 2016
(86) PCT No.: PCT/EP2016/001216

§ 371 Date: Jan. 22, 2018

(30) Foreign Application Priority Data
Jul. 23, 2015 (DE) 10 2015 009 561.7

(51) Int. Cl. B01D 53/04; B01J 20/28

(52) U.S. Cl. CPC B01D 53/0462; B01D 53/0438; B01J 20/28004; B01D 2253/34; B01J 20/28023; B01D 2253/25; B01J 20/28021

(57) ABSTRACT

The invention relates to a device for adsorbing at least one component from a gas mixture by temperature swing adsorption, comprising a through-flow chamber (7) and a cooling chamber (8) for accommodating a heat transfer fluid, wherein the through-flow chamber (7) is separated from the cooling chamber (8), wherein the through-flow chamber (7) has an adsorbent (1) which contains a plurality of (two or more) adsorbent bodies containing a porous and adsorptively additive first material (3) and a second material (4) having better thermal conductivity as compared to the first material (3) and wherein the first material (3) is at least partly surrounded by the second material (4).

Die invention relates to a device for adsorbing at least one component from a gas mixture by temperature swing adsorption, comprising a through-flow chamber and a cooling chamber for accommodating a heat transfer fluid, wherein the through-flow chamber is separated from the cooling chamber by a wall, wherein the through-flow chamber is at least partially surrounded by the cooling chamber, wherein the through-flow chamber contains at least one adsorbent which includes a plurality of adsorbent bodies, wherein each adsorbent body contains a porous and adsorptively active first material and a second material which has better thermal conductivity than the first material. The invention further relates to a temperature swing adsorption method in which the claimed device is used.

In the prior art, the Temperature Swing Adsorption (TSA) method is known for precipitating molecules out of a gas mixture stream, for example. Until now, this method has been use in industry mainly to remove trace components (less than 1 vol % of the gas mixture stream) from gas mixtures. As a rule, two containers (adsorbers) filled with adsorptively active material are used for the TSA method, and are operated alternately. While one container is in adsorption, hot regenerating gas is passed through the other, heating it up. The adsorption capacity of the adsorptively active material (adsorbent) falls as the temperature rises, so the trapped components are desorbed. The desorbed components are diluted with the regenerating gas and flushed out of the adsorber. The use of regenerating gas also has the effect of lowering the partial pressure of the adsorbed component in the gas phase, and thus assists the desorption of the trapped trace components. The heating and cooling times are usually limited by the quantity of regenerating gas that is available and/or usable, and are typically in the range of several hours (more than three hours). Consequently, cycle times are mostly considerably longer than six hours.

If the adsorber is not heated and cooled directly by regenerating gas but indirectly with the aid of a heat transfer fluid which is not in direct contact with the adsorbent, considerably shorter cycle times (less than four hours) are possible. Therefore, this is also referred to as a “Rapid TSA method”. A corresponding device such as for example a shell and tube heat exchanger with adsorbent in the tubes and a heat transfer fluid (for example water, steam or thermal oil) may be mounted on the side of the casing. Other arrangements, for example with the adsorbent on the side of the casing or rectangular channels are also possible, however. An indirectly heated and cooled adsorber also offers further advantages over a standard TSA method. Thus for example, it is also possible to remove higher concentrations of a component from a gas mixture. Significantly less or even no regenerating gas is needed, and the trapped component can then be recovered at a higher concentration. Compared with alternative separation methods such as washing and pressure swing adsorption, the trapped component may also be recovered under high pressure.

Patent application EP 1 291 067 A2 describes a Rapid TSA method with indirect heating and cooer heating and cooling. The construction thereof resembles a shell and tube heat exchanger with an adsorbent bed of standard material in the tubes.

Most adsorbents used as standard, such as molecular sieves, silica gels or alumina gels in the form of beads, extrudates or rods, have very low thermal conductivity (0.1 to 0.6 W/(m K)). In order to uniformly heat or cool a bed consisting of a corresponding material (particularly mainly) by heat transfer via a tube wall or other separating layer, relatively long times (e.g., more than 30 minutes) are needed for thick adsorbent layers (thicker than 5 cm, for example). In order to shorten the heating times and cooling times, it is possible to increase the layer thickness and/or the heat transfer surface area using installations with good thermal conductivity, such as fins or helical structures. Patent application WO 2011/022 636 A2 describes a similar design with a bed consisting of standard materials, wherein installations (made of aluminium for example) having good thermal conductivity are introduced into the bed to ensure that the bed is heated and cooled rapidly.

However, the installations entail significantly greater mass of inert wall material, which must be heated and cooled in every cycle. Moreover, installations of such kind may make it more difficult to fill and empty the adsorber. For example, if in the installations are in the form of permanent helical structures, material that tends to clump and no longer flows during operation can become very difficult to remove if the material is not directly accessible.

The disadvantages of the known prior art outlined here are at least partly solved with the invention that will be described in the following text. The inventive features are defined in the independent claims, and advantageous variants thereof are described in the respective dependent claims. The features of the claims can be combined in any technically practical manner, wherein the notes in the following description and the features from the drawing containing still further variants of the invention may also be included.

According to claim 1, a device for adsorbing at least one component from a gas mixture by temperature swing adsorption, comprising a through-flow chamber and a cooling chamber to accommodate a heat transfer fluid is suggested, wherein the through-flow chamber is separated from the cooling chamber by an impermeable, heat-conducting wall, wherein the through-flow chamber is at least partially surrounded by the cooling chamber, wherein the through-flow chamber has an adsorbent which contains a plurality of adsorbent bodies, wherein each adsorbent body contains a porous, adsorptively active first material and second material which has better thermal conductivity than the first material, wherein the first material is at least partially surrounded by the second material, wherein the first material is permanently connected to the second material.

In the following text, the adsorbent according to the invention will be described in the Rapid TSA method. In this context, however, the heat transfer fluid and the adsorbent are separated from each other by a separating layer or wall (a steel tube, for example) which is impermeable for the gas mixture that is to be purified and for the heat transfer fluid, but which has good thermal conductivity. The adsorbent contains a plurality of adsorbent bodies in the form of beads, extrudates, rods, tubes, hollow fibres, or other particles in any form. The adsorbent body has a porous, adsorptively active first material (including for example a molecular sieve, activated charcoal, silica gel, alumina gel or other suitable substances or structures) and a second material with good thermal conductivity (for example, a thermally conductive polymer, a metal or similar suitable substances). Due to the porosity of the first material, the gas mixture is able to pass into the first material, where it can be at least partially adsorbed. Due to the busser thermal conductivity of the second material, which is connected particularly on the molecular level with the first material, heating of the first material is accelerated, which in turn accelerates the process of desorption and regeneration of the adsorbent. In the same way, the cooling process of the first material is improved, thereby enhancing the adsorption properties of the adsorbent, that is to say the first material. In this way, the total cycle time is shortened.

For the present purposes, the term adsorbent body is understood to mean an integral body which can be used in its entirety to fill the through-flow chamber. The adsorbent refers to the totality of the materials inserted in the through-flow chamber, which serve to remove at least one component from a gas mixture. These materials may be adsorptive and/or thermally conductive. The adsorbent contains a plurality of adsorbent bodies. Each individual adsorbent contains both of the materials described above, which are combined in the manner according to the invention in the adsorbent body.

The first material is preferably located inside and is at least partially, preferably completely surrounded by the second material. The term “partially surrounded” is intended to mean in particular that at least 50% of the surface of the first material, preferably 70%, particularly preferably 90% of the surface of the first material is covered by the second material. For example, if the first material is cylindrical in shape, the second material coats the lateral surface of the first material in the manner of a casing.

Normally in the manufacturing process for the first material, many powdered adsorptive particles are joined with a binding agent to produce a certain shape. For these binding agents, a permeable, inorganic substance or polymer is used. An adsorptive first material manufactured in this way is often used for adsorbing a gas mixture. This powdered, adsorptive particle has a diameter of a few micrometres. One example of such is extruded activated charcoal. In the case of extruded activated charcoal, powder-activated charcoal (PAC) is extruded with a binding agent to form a cylindrical activated charcoal block with a particle diameter between 0.8 and 4.0 millimetres and then heated. A material produced by such a method may be considered to be the first material, for example. However, the first material might also be produced solely from adsorptive particles without any binding agent.

According to the invention, the through-flow chamber is separated from the cooling chamber by an impermeable, thermally conductive wall, wherein the through-flow chamber is at least partially surrounded by the cooling chamber. The cooling chamber surrounds the through-flow chamber in such manner that the through-flow chamber is provided inside like a core and the cooling chamber like an outer mantle. The advantage of this arrangement is that the adsorbent can be added to and removed from the through-flow chamber more easily, since there are no additional installations in the through-flow chamber that would hinder filling and emptying. For example, when a material that clumps and loses its ability to flow during operation is not directly accessible, it can be very difficult to remove it if permanent installations are in place. Moreover, the chambers are easier to manufacture and involve lower costs if their construction is less complex.

The term “partially surrounded” is intended particularly to mean that at least 50%, preferably 70%, particularly preferably 90%, most particularly preferably 100% of the surface of the wall that delimits the through-flow chamber is in contact with the cooling chamber, and thus is able to cooled or heated thereby. The wall which delimits the through-flow chamber is preferably coincident with the impermeable heat conducting wall by which the two chambers are separated from one another. This wall is preferably in the form of a metal tube.

When in the form of a bed, for example, but also in other advantageous arrangements of the material, the second material with good thermal conductivity is in direct contact with one or more adjacent adsorbent bodies (particularly with the second material of said bodies). This direct contact by the adsorbent in the adsorbent bed gives rise to conductor paths with good thermal conductivity. The transfer of heat between the heat transfer fluid and the centre of the bed may thus be improved, and shorter heating and cooling times may be achieved. According to one example in this respect, for a tube with an internal diameter of 50 mm and a bed with effective thermal conductivity of 0.12 W/(m*K), the heating time from 20° C. to 200° C. may be expected to take about 35 minutes. With a bed with enhanced effective thermal conductivity of e.g. 0.3 W/(m*K), this period for heating from 20° C. to 200° C. is only about 15 min.

The first material is connected to the second material permanently. The connection between the two materials may be a positive, non-positive and/or material bond, so that the two materials may be considered as a single item. The first material is located in the interior, and the second material surrounds the first material on the outside, thereby creating a single-part adsorbent body. With this special form of the adsorbent body, the ratio between the adsorptive material and the thermally conductive material can be optimised in advance during manufacture of the adsorbent body, thus enabling the energy for cooling or heating the adsorbent to be used efficiently in each cycle.

The second material is preferably applied physically to the surface of the first material in the manner of a coating. This coating method is used to apply a layer to the surface of a workpiece. In this case, the workpiece is the first material. The second material is preferably not completely impermeably coated on the first material, so that the gas to be adsorbed is able to infiltrate the first adsorptive material through the gap. The coating method might be for example thermal spraying, spray coating, immersion coating. According to a further advantageous embodiment of the device, the second material is permeable to a substance that is to be adsorbed such as carbon dioxide. The first material of the at least one adsorbent body is preferably coated on an outer surface thereof, or on surface thereof facing the second material, so that the first material is permanently bonded with the second material.

According to a further advantageous embodiment of the device, the at least one adsorbent body is formed according to at least one of the following shapes:
bead;
extrusion body; and
hollow body, particularly a tube or hollow fibre.

If the adsorbent body is in the shape of a bead, it is particularly easy to obtain good conductivity with a bed of the adsorbent. Extrusion bodies are particularly simple to manufacture, and structures can be created that are easily installed, such as a rod shape, for example. A hollow body provides a large contact area with low volumetric mass, which is advantageous both for thermal conductivity and adsorption. Both the bead and the extrusion body can be formed as hollow bodies. It should be noted that the term extrusion body is used to refer not only to those adsorbent bodies which are produced by an extrusion method, but also any body shaped with a (substantially) constant cross section over the (entire) length of the body.

The diameter of the bead-like adsorbent body is particularly in the range smaller than 30 mm and larger than 1 mm, preferably smaller than 20 mm and larger than 1.5 mm, still more preferably smaller than 10 mm and larger than 2 mm. The size of an irregularly shaped adsorbent body is represented by its equivalent diameter, which is understood to be a diameter of a geometrically volume-equivalent sphere with the diameter of a sphere having the same volume as the adsorbent body. Thus for example, the size of the equivalent diameter of the irregular adsorbent body is equivalent to the diameter of the spherical adsorbent body.

The size of a tubular adsorbent body cannot be determined using the volume-equivalent spherical diameter, because the length of the tubular adsorbent body depends on the length of the device. In this case, the cross-section of the tubular adsorbent body is preferably used instead. For a round cross-section, the diameter is particularly smaller than 30 mm and larger than 1 mm, preferably smaller than 20 mm and larger than 1.5 mm, still more preferably smaller than 10 mm and larger than 2 mm. In the case of an irregular cross-section, the diameter is determined with an area-equivalent circular diameter which corresponds to the area of the circular cross-section.

According to a further aspect of the invention, a temperature swing adsorber for separating substances from a gas mixture is suggested, comprising a through-flow chamber and a cooling chamber, wherein the through-flow chamber is separated from the cooling chamber by a wall which is impermeable for the gas mixture that is to be purified and for the heat transfer fluid, but which has good thermal conductivity, wherein the through-flow chamber accommodates an adsorbent according to the preceding description.

The preferably good heat conducting properties of the second material serve to shorten the temperature change time. Particularly in a variant with a wall having sufficient thermal conductivity and adsorbent bodies with an outer coating of the second material (preferably permeable for the component that is to be adsorbed), it is possible to create a thermal bridge. This serves to reduce the cycle time significantly.

According to a further advantageous embodiment of the temperature swing adsorber, the at least one adsorbent body of the adsorbent is at least partially arranged in arranged so as to be fastenable inside the through-flow chamber.

Given the suggested capability of the at least one adsorbent body to be fastenable inside the through-flow chamber, for example by a structural mesh or holders inside the through-flow chamber or by introduction of a plurality of hollow adsorbent bodies as a bundle into the through-flow chamber, which otherwise contains no components, replacement is simple and at the same time a defined adsorbent surface is assured.

The problem the invention is designed to address is further solved with a temperature swing adsorption method which uses a temperature swing adsorption device according to the invention and the adsorbent described previously, wherein a gas mixture is passed through the through-flow chamber and at least one component of the gas mixture is adsorbed on and in the adsorbent, and wherein heat is transferred between the first material of the adsorbent bodies and the heat transfer fluid, and particularly via the second material of the adsorbent bodies and the wall of the cooling chamber which carries the heat transfer fluid (in the present case of course the cooling chamber is also used to heat adsorbent and may also be referred to as a warming or heating chamber as appropriate).

With the invention suggested here, it is possible to shorten the cycle time of a temperature swing adsorption method significantly, wherein awkward installations can be dispensed with and at the same time the thermal mass is kept small. With the improved yield, optionally it may be possible to reduce the size of the temperature swing adsorber. Thus it is possible to use the same quantity of adsorbent with tubes and separating structures between the adsorbent and the heat carrier medium taking up less space. A lower energy requirement due to a more favourable mass ratio between the adsorbent and the wall of the temperature swing adsorber is also possible, because less inert material has to be heated and cooled.

In the following text the invention described above will be explained in detail in the context of the relevant technical background with reference to the associated drawings, which show preferred variants thereof. The invention is in no way limited by the purely schematic drawings, and it should be noted that the drawings are not based on a consistent scale and are not suitable for specifying size relationships. The drawings show, in

FIG. 1: a temperature swing adsorption device with bead-shaped adsorbent bed; and

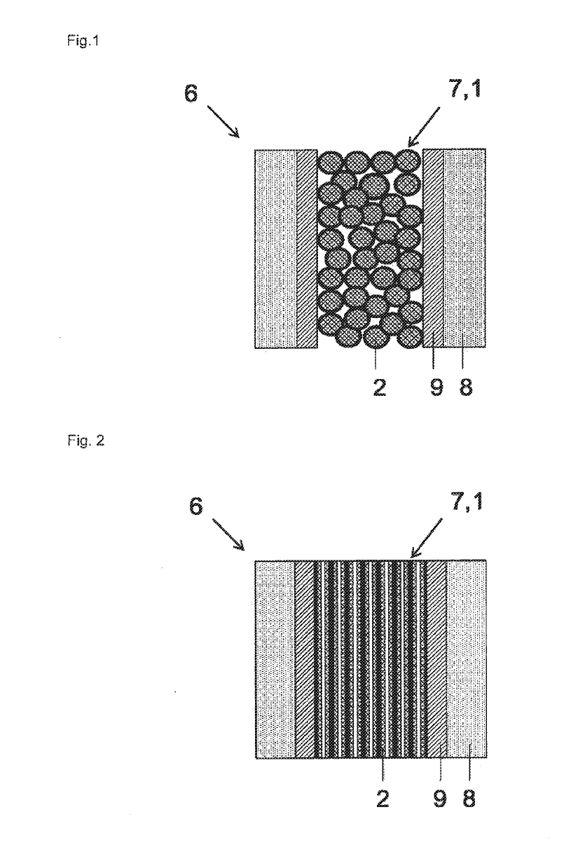

FIG. 2: a temperature swing adsorption device with arranged hollow adsorbent bodies;

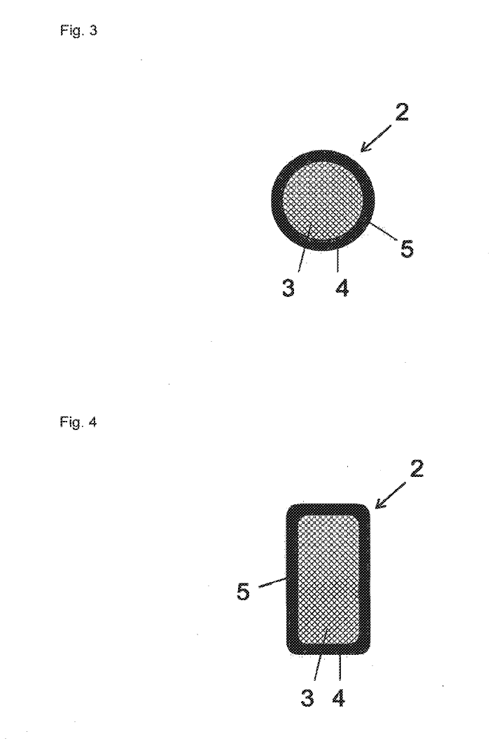

FIG. 3: a bead shaped adsorbent body;

FIG. 4: an adsorbent body with rectangular cross-section;

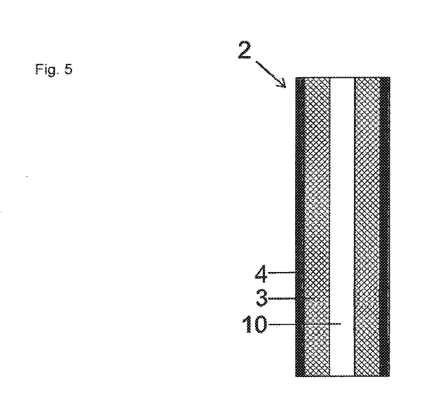

FIG. 5: an adsorbent body as hollow extrusion body.

FIG. 1 shows a temperature swing adsorber 6 for a Rapid-TSA method. A through-flow chamber 7 with a bed of adsorbent 1 is arranged in the interior of temperature swing adsorber 6. Through-flow chamber 7 is separated from a cooling chamber 8 by an impermeable wall 9 with good thermal conductivity. Said wall 9 delimits through-flow chamber 7 and is separated from the adsorbent 1 so that adsorbent 1 can be replaced easily. In this context, cooling chamber 8 is provided like an outer casing of the temperature swing adsorber 6, which completely surrounds through-flow chamber 7. Cooling chamber 8 is used to hold a heat transfer fluid, e.g., water, steam or thermal oil. Wall 9 is made of steel, for example. Adsorbent 1 is on one side of wall 9 and the heat transfer fluid is on the other, so that the heat can be transferred between the heat transfer fluid in cooling chamber 8 and the adsorbent 1 in through-flow chamber 7 via wall 9.

In FIG. 1, adsorbent 1 is equal to the total number of adsorbent bodies 2. Each adsorbent body is constructed as an integral bead which consists of an adsorptive first material and a second, thermally conductive material which completely surrounds the first material. This second material is permeable for the component that is to be adsorbed, with the effect that the component is able to infiltrate the first material where it can be adsorbed. This bead-shaped adsorbent body is shown again in detail in FIG. 3. This special adsorbent body 2 and its arrangement inside temperature swing adsorber 6 make it easy to fill and empty adsorbent 1 and at the same time makes efficient temperature swing adsorption possible through indirect heat transfer.

It is noteworthy that direct contact between the adsorbent bodies 2 with each other forms a conductive structure via which a temperature swing of adsorbent 1 can be accelerated. The heat in adsorbent 1 is distributed more evenly by the touching outer surfaces of the beads, that is to say the second material.

FIG. 2 shows a temperature swing adsorber 6 for a Rapid-TSA method. A through-flow chamber 7 with a regulated arrangement of adsorbent 1 is arranged inside temperature swing adsorber 6. Through-flow chamber 7 is separated from a cooling chamber 8 by an impermeable wall 9 with good thermal conductivity. Said wall 9 delimits through-flow chamber 7 and is separated from adsorbent 1. The adsorbent shown here contains a plurality of adsorbent bodies 2, via which a temperature swing of adsorbent 1 may be accelerated. This adsorbent body 2 is tubular and extends in the lengthwise direction of temperature swing adsorber 6. A cavity can be seen in the core of the adsorbent body. The second material is applied to the outer surface of adsorbent body 2, and the first material is located between the cavity and the second material. The gas mixture to be treated flows into through-flow chamber 7, and at least one component is adsorbed by the first material. The heat between cooling chamber 8 and adsorbent 1 is transferred via wall 9 and also via the touching adjacent outer surfaces of adsorbent bodies 2, that is to say the second thermally conductive material. This tubular adsorbent body 2 will be shown in detail later, in FIG. 5.

FIG. 3 shows an adsorbent body 2 which is spherical. The first material 3, which is designed to adsorb, is located in the core of adsorbent body 2. In this case the second material 4 is applied to the outer surface 5 of the first materials 3 in the form o a coating and is permeable for a gas to be separated or a component of a gas mixture that is to be adsorbed. The first material 3 is completely surrounded by the second material 4. This bead-shaped adsorbent body has a diameter smaller than 30 mm and larger than 1 mm. Accordingly, a number of adsorbent bodies 2 depending on the size of the temperature swing adsorber is inserted in the through-flow chamber for the purpose of adsorption.

FIG. 4 shows an adsorbent body 2 similar to the one in FIG. 3, wherein this adsorbent body 2 has a rectangular cross-section. An adsorbent body of such kind has an equivalent diameter smaller than 30 mm and larger than 1 mm.

FIG. 5 shows a lengthwise section through an adsorbent body 2 in the form of an extrusion body, wherein in this case a cavity 10 is visible in the core, and is surrounded by first material 3. First material 3 in turn is surrounded by second material 4. This tubular adsorbent body 2 has a cross-sectional diameter smaller than 30 mm and larger than 1 mm. The adsorbent body might be of any length, depending on how high the temperature swing adsorber is. A plurality of the tubular adsorbent bodies of which the adsorbent consists is introduced into the through-flow chamber.

### LIST OF REFERENCE SIGNS

| | |
|---|---|
| 1 | Adsorbent |
| 2 | Adsorbent body |
| 3 | First material |
| 4 | Second Material |
| 5 | Outer surface |
| 6 | Temperature swing adsorber |
| 7 | Through-flow chamber |
| 8 | Cooling chamber |
| 9 | Wall |
| 10 | Cavity |

1. Device for adsorbing at least one component from a gas mixture by temperature swing adsorption, comprising a through-flow chamber (7) and a cooling chamber (8) for accommodating a heat transfer fluid, wherein the through-flow chamber (7) is separated from the cooling chamber (8) by an impermeable, thermally conductive wall (9), wherein the through-flow chamber (7) is at least partially surrounded by the cooling chamber (8), wherein the through-flow chamber (7) contains an adsorbent (1) which includes a plurality of adsorbent bodies, wherein each adsorbent body contains a porous and adsorptively active first material (3) and a second material (4) which has better thermal conductivity than the first material (3), wherein the first material (3) is at least partially surrounded by the second material (4), characterised in that the first (3) and the second material (4) are permanently bonded.

2. Device according to claim 1, characterised in that the first material (3) is completely surrounded by the second material (4).

3. Device according to claim 1, characterised in that the first material and the second material are permanently bonded on the molecular level.

4. Device according to claim 1, characterised in that the second material (4) is physically coated on the surface of the first material (3).

5. Device according to claim 1, characterised in that the second material (4) is permeable for a substance that is to be adsorbed.

6. Device according to claim 1, characterised in that the impermeable, thermally conductive wall (9) delimits the through-flow chamber (7).

7. Device according to claim 1, characterised in that the adsorbent bodies (2) are arranged in the through-flow chamber (7) in such manner that the second materials (4) of adjacent adsorbent bodies (2) touch each other.

8. Device according to claim 1, characterised in that the adsorbent bodies (2) are arranged and/or fixed inside the through-flow chamber (7) so that they are at least partly or entirely regulated.

9. Device according to claim 1, characterised in that the adsorbent bodies (2) are constructed as one of the following body types:
bead;
extrusion body; and/or
hollow body, particularly a tube or hollow fibre.

10. Device according to claim 1, characterised in that the equivalent diameter of the adsorbent bodies is larger than 0.5 mm and smaller than 30 mm, preferably larger than 1 mm and smaller than 20 mm.

11. Device according to claim 9, characterised in that the adsorbent body is conformed as a tube or hollow fibre, and that the cross-sectional diameter of the tubular or hollow fibre adsorbent bodies is larger than 0.5 mm and smaller than 30 mm, preferably larger than 1 mm and smaller than 20 mm.

12. Device according to claim 9, characterised in that the adsorbent body has the form or a tube or hollow fibre, and that a cavity is delimited by the first material inside the absorbent body, wherein the first material is located between the cavity and the second material.

13. Device for adsorbing at least one component from a gas mixture by temperature swing adsorption, comprising a through-flow chamber (7) and a cooling chamber (8) for accommodating a heat transfer fluid, wherein the through-flow chamber (7) is separated from the cooling chamber (8) by an impermeable, thermally conductive wall (9), wherein the through-flow chamber (7) is at least partially surrounded by the cooling chamber (8), wherein the through-flow chamber (7) contains an adsorbent (1) which includes a plurality of adsorbent bodies, wherein each adsorbent body contains a porous and adsorptively active first material (3) and a second material (4) which has better thermal conductivity than the first material (3), wherein the first material (3) is at least partially surrounded by the second material (4), wherein the first (3) and the second material (4) are permanently bonded, characterised in that the adsorbent body is used.
